(19) United States
(12) Patent Application Publication
(10) Pub. No.: US 2005/0082770 A1
(43) Pub. Date: Apr. 21, 2005

(54) Internal surface chucking mechanism and method

(76) Inventors: Rami Siev, Kiryat Haim (IL); Gadi Siev, Kiryat Haim (IL); Ahron Siev, Farmington Hills, MI (US); Daniel Dunner, Moutier (CH)

Correspondence Address: COHEN, PONTANI, LIEBERMAN & PAVANE, 551 FIFTH AVENUE, SUITE 1210, NEW YORK, NY, 10176, US

(21) Appl. No.: 10/505,401

(22) PCT Filed: Feb. 18, 2003
(86) PCT No.: PCT/IL03/00127

(30) Foreign Application Priority Data
Feb. 20, 2002 (US) 60357995

(51) Int. Cl. B23B 31/16

(52) U.S. Cl. 279/2.03

(57) ABSTRACT

An internal surface chucking mechanism (ISM) for gripping and for releasing an internal surface of a workpiece (W) in process on a processing machine is configured for reversible exchange with an external surface chucking mechanism (EXS) dedicated to grip an external surface of the workpiece. The ISM fits machinery where the workpiece is rotating and is non-rotating, in a first mode with the EXS, and in a second mode with the ISM, and vice-versa. A fluid conduit inside the ISM provides fluid, such as oil, for exhaust adjacent and opposite the workpiece. An appropriately oriented exit outlet (353) directs a stream of fluid to impinge on the workpiece, to eject it from the ISM when released from grip. The fluid cools and lubricates both the ISM and the workpiece.

### TECHNICAL FIELD

The invention relates to an internal surface chucking mechanism (ISM) and to a method for holding a workpiece in a processing machine, to the ability of reversible exchange of the ISM with an external surface chucking mechanism (EXS), and to the use of a stream of fluid exiting from the inside of the ISM to eject the workpiece, to cool and lubricate the workpiece and the ISM, and to prevent the ingress of matter.

### BACKGROUND ART

In general, a processing machine for holding a workpiece in process is supplied with an external surface chucking mechanism, referred to below as EXS. Although well known to the art, an EXS is first described and shown in FIG. 1 for purpose of reference. Even though the invention is applicable to multiple types of workpiece processing machines, the examples provided below refer to turning machines, such as lathes.

FIG. 1 illustrates a prior art spindle assembly 1 housing an EXS. Three parts of the spindle assembly, which come in contact with the EXS, are referred to as the interface components, and are described below. The operation of the spindle assembly 1, of the interface components, and of the EXS, is controlled by commands given by, or to, the processing machine. The processing machine, which is not shown in FIG. 1, and the spindle assembly 1, are not described since both are well known to the art.

The interface components include a spindle 3, a cap-nut 5, and a push rod 7, all coming in direct contact with the EXS and with the IMS, and described below. It is understood that the interface components and the EXS are rotative in the case of a lathe.

The spindle 3 is configured as a hollow tube with an inside 3IN, and a generally smooth constant outer diameter, defining a longitudinal axis A. The spindle 3, with an open front portion 9 and a back portion 11 defines directions as respectively, a front F or a forward direction F, and a back B, or rear, or backward direction B, common to the orientation of the parts of the spindle 3 in the various Figs. The open front portion 9 of the spindle 3 with a front face 9F, has an inner diameter 9ID larger than the inner diameter 11ID of the back portion 11, forming a front facing arresting step 13 which separates between the front portion 9 and the back portion 11. The front extremity of the spindle 3 is covered with an external screw thread 9ST.

The cap-nut 5 has an open back end with an internal screw thread 5ST mating the screw thread 9ST of the spindle 3. A restriction with an inner diameter 6 starting to the front of the internal screw thread 5ST forms an arresting step 15 protruding radially inward and facing backward. The front end of the cap-nut 5 has a bottom 19 pierced by an opening bore 17 smaller than the inner diameter restriction 6. Means for gripping the cap-nut for attachment to and unscrewing from the spindle 3 are not shown in the Figs. When in engagement with the screw thread 9ST of the spindle 3, the arresting step 15 on the inside of the cap-nut 5, stops the cap-nut in abutment with the front face 9F of the spindle 3 and confines the EXS to the inside 3IN of the spindle.

The push rod 7, which is a tube open towards the front F, of which only a portion with a front face 7F is seen in FIG. 1, is concentrically supported on the inside 3IN of the back portion 11 of the spindle 3. The push rod 7 is operable in axial translation within the spindle 3, from a first extreme backward retracted position, not shown in FIG. 1, to a second extreme forward extended position 21, in which the front face 7F of the push rod 7 protrudes forward of the arresting step 13, into the front portion 9 of the spindle 3, to positively operate the EXS.

The EXS is built essentially of a collet actuator 23, of an outer surface hollow gripping chuck 25, or OSC 25, and of a helical spring 27, all better seen in FIG. 2, where the spindle assembly 1 is deleted.

The hollow, substantially axi-symmetric collet actuator 23 is received for sliding translation and retained inside the front portion 9 of the spindle 3, forward of the arresting step 13. The motion of the collet actuator 23 is limited backward, by the arresting step 13, and forward, by the bottom of the cap-nut 5.

On the inside, the collet actuator 23 has a generally constant collet actuator inner cylindrical surface 31 of uniform inner diameter, but for a thick lip 33 at the extremity of the back portion, and a conical opening 35 in the front portion. The thick lip 33 protrudes radially inward to form both a front facing spring shoulder 33F sufficient to arrest a back end 27B of the helical spring 27 disposed inside the collet actuator inner cylindrical surface 31, and a back facing push rod shoulder 33B for receiving the front face 7F of the push rod 7.

In the front portion of the collet actuator 23, an inner conical opening 35 forms a female cone wide open at the front and tapering backward to the collet actuator inner cylindrical surface 31. On the outside, the collet actuator 23 has a generally cylindrical smooth outer surface 37 with a constant outer diameter but for a low flange 39 protruding radially outward at the front portion extremity.

The outer surface chuck 25, or OSC 25, is hollow and positioned in concentric alignment inside the collet actuator 23. The outside of the OSC 25 has a front portion with a short front cylindrical portion 41 and a conical male flange 43, and a back portion. The back portion of the OSC 25 has a cylindrical smooth outer diameter surface 45 terminating in a back extremity OSC base 47 resting on the front end 27F of the helical spring 27.

The male conically shaped flange 43 protrudes radially outward of the front cylindrical portion 41 outer diameter to form a front facing jaw shoulder 49, and tapers backward, to the outer diameter surface 45. The male conically shaped flange 43 conforms to the internal female cone of the opening 35 accommodated in the collet actuator 23.

The short front cylindrical portion 41, to the front of the jaw shoulder 49 is freely received inside the opening bore 17 concentrically piercing the thickness of the cap-nut bottom 19 of the cap-nut 5. It is the cap-nut bottom 19 which retains the front facing jaw shoulder 49 inside the collet actuator 23, and therewith, the whole EXS.

The front portion of the OSC 25 is slit radially from the front cylindrical portion 41 to the back of the conical male flange 43 to form a plurality of jaws 51, e.g. three jaws 51, separated from each other by slits 53, for gripping outer surfaces of a workpiece. Normally, the jaws 51 are open, but the exertion of radial inward forces close the jaws inward. It is the frontward motion of the collet actuator 23 that closes the jaws 51 on the workpiece, not shown in FIG. 1.

It is noted that the EXS resides in a space referred to as an inner chamber 70, defined as the volume enclosed within both the front portion 9 of the spindle 3 and of the cap-nut 5, and aligned with the axis A. The parts of the EXS housed inside the inner chamber 70, all coaxially aligned, releasable and retrievable, come in contact solely with the interface components, thus with the cap-nut 5, the spindle 3, and the push rod 7.

It is also noted that in the description of the interface components, keys or pins possibly used for the coupling of jointly rotating parts and for relative translation displacement have not been mentioned and will not be described below, for the sake of simplicity.

In operation, when the push rod 7 resides in the first extreme back retracted position, the back end 27B of the helical spring 27 biases the collet actuator thick lip 33 against the front facing arresting step 13, while the front end 27F of the helical spring 27 urges the jaw shoulder 49 of the OSC 25 against the inner bottom 19 of the cap-nut 5. Thereby, the jaws 51, now not urged inwardly by the inner female front conical opening 35 of the collet actuator 23, are free to reside in their normally open position.

To grip an outer surface of a workpiece, not shown in FIGS. 1 and 2, the push rod 7 is commanded to translate forward, to push the collet actuator 23 forward. Thereby, the female front conical opening 35 acts upon the male cone 43 and closes the jaws 51 radially inward to grip an outer surface of a workpiece.

In practice, when an EXS grips an outer surface of a workpiece, and the jaws of the EXS cover an external portion of that workpiece, inevitably, the covered portion is prevented from being processed. Furthermore, the jaws of the EXS may leave unallowable marks that mar the outer surface finish of the workpiece. Moreover, a short workpiece is difficult to grip with an EXS.

In U.S. Pat. No. 5,816,581, Chase discloses an “Inner Diameter Chuck Providing Registration and Operable by Push or Pull to Attach a Workpiece”, which in other words, relates to an inner surface gripping chuck for retaining a workpiece by an inner diameter. Chase opts for the conversion of a processing machine by mounting a special purpose structure thereon with “ . . . an attached extender 25” together with the addition of numerous other parts.

In workpiece processing facilities, an internal surface chucking mechanism (ISM), or Inner Diameter Chuck as called by Chase, is often required and very useful. One problem is that available financial resources may prohibit the acquisition and the dedication of machinery and equipment solely to the purpose of inner surface gripping, as required by the teachings of Chase.

Another problem with the solution provided by Chase is that the geometry and initial external configuration of the processing machine is altered, causing at least inconvenience, if not demanding replacement of jigs, fixtures and gauges.

A further problem with the solution provided by Chase is that the implementation thereof is cumbersome, expensive and time consuming.

### DISCLOSURE OF THE INVENTION

The present invention provides a method and an ISM product permitting the in situ reversible exchange of an EXS with an ISM for operation with a processing machine, such as inside a spindle assembly 1. The reversible exchange is as easy as the routine fast exchange, e.g., of a cutting tool in the case of a lathe. Advantage is taken of the inner chamber 70 existing in the spindle assembly 1 of a processing machine, from which the EXS is retrieved and replaced by an ISM. The ISM is constructed with only a few parts without actually enlarging and adding to the maintenance expenses of the tooling inventory. Evidently, the need for dedicated facilities is avoided since the ISM transforms existing equipment into adaptive machinery by allowing replacement of an EXS with an ISM and vice versa.

Furthermore, a fluid flow communication conduit is entered to the inside of the ISM and fluid exit bores are appropriately added. The stream of fluid exiting the ISM, emanating from a source of fluid under pressure, ejects the workpiece chucked in the processing machine when the grip thereon is released. Moreover, the stream of fluid cools and lubricates both the ISM and the workpiece and prevents ingress of outside matter into the ISM.

### SUMMARY

It is an object of the present invention to provide an internal surface chucking mechanism (ISM) comprising a collet for gripping an internal surface accommodated in a workpiece.

It is another object of the present invention to provide an ISM configured for exchangeable reversible replacement with a commercially available external surface chucking mechanism (EXS) comprising a collet for gripping an external surface of the workpiece. By exchanging and replacing an EXS with an ISM, and vice-versa, the processing machine is converted from a first state to a second state.

It is a further object of the present invention to provide an ISM with a passage for fluid flow supplied by a source of fluid under pressure and exiting the ISM adjacent and opposite the workpiece, to eject the workpiece from the ISM when grip thereon is released.

It is yet another object of the present invention to provide an ISM and a method for implementing such an ISM comprising a coupling mechanism activable for gripping and for release of a workpiece in process on a processing machine, the workpiece defining an external surface and an internal surface configured for access from the outside. The processing machine comprises an inner chamber defining an axis and a volume of space inside the processing machine,
an external surface chucking mechanism (EXS) releasably and retrievably retained in axial alignment in the inner chamber and configured for gripping and for releasing an external surface of the workpiece in process on the processing machine, and
a push rod operatively associated with the EXS to controllably command gripping and release of the external surface of the workpiece in process. The ISM is characterized in that:
the ISM comprises a bushing defining a bushing outside and a bushing inside, the bushing outside being configured to be retrievably received in axial alignment inside the inner chamber, and the bushing inside being configured for receiving the coupling mechanism, and
the ISM is configured for insertion and retention in the inner chamber to provide reversible exchange in replacement of the EXS, for operative association with the push rod to activate the coupling mechanism, and for retrieval from the inner chamber,
whereby retrieval of the EXS from the inner chamber and insertion therein of the IMS in replacement, provides operation of the processing machine in a first configuration with an EXS, and in a second configuration with an ISM, and vice versa. The ISM and the EXS are mutually and reversibly exchangeable in situ.

The ISM is operable with a processing machine operating a process selected, alone and in combination, from the group of processes consisting of material removal, fastening, joining, surface treatment, and quality assurance. Furthermore, the ISM is configured for operation both when rotative and when non-rotative, thus with a processing machine comprising a rotating spindle.

The processing machine defines an initial external configuration when operating an EXS, and the ISM is further characterized in that exchange of the EXS with the ISM maintains unaltered the initial external configuration of the processing machine.

It is but another object of the present invention to provide an ISM and a method for implementing an ISM comprising a coupling mechanism activable for gripping and for release of a workpiece in process on a processing machine, the workpiece defining an external surface and an internal surface configured for access from the outside, the processing machine comprising:
an inner chamber defining an axis and a volume of space inside the processing machine,
an external surface chucking mechanism (EXS) releasably and retrievably retained in axial alignment in the inner chamber and configured for gripping and for releasing the external surface of the workpiece in process on the processing machine, and
a push rod operatively associated with the EXS to controllably command gripping and release of the external surface of the workpiece in process. The ISM is characterized in that:
the ISM comprises at least one fluid flow inlet coupled in fluid flow communication to at least one exit bore for fluid flow outlet, the former receiving a flow of fluid under pressure from at least one source of fluid and the latter discharging a controlled stream of fluid flow, and
the at least one exit bore is oriented and located respectively, toward and adjacent the workpiece, for aiming discharge of the controlled stream of fluid to impinge on and to eject the workpiece from the ISM when the coupling mechanism is activated to release the workpiece, whereby the ISM is configured for controlled ejection of the workpiece.

The controlled stream of fluid acts on either one and on both the ISM and the workpiece by performing a function selected alone and in combination form the group of functions consisting of cooling and of lubricating, where the fluid is defined as an oil, and the oil is selected alone and in combination from the group of oils consisting of cooling oils and lubrication oils.

The ISM defines an inside and an outside, and the controlled stream of fluid flow is discharged from the inside of the ISM to the outside. The ISM further comprises slits providing passage for fluid flow communication from the inside of the ISM to the outside, and
the controlled stream of fluid is discharged from the inside of the ISM via the at least one exit bore and via the slits comprised in the ISM, whereby ingression of matter from the outside to the inside of the ISM is prevented.

### BRIEF DESCRIPTION OF THE FIGURES

In order to better understand and more fully appreciate the invention and to see how the same may be carried out in practice, a preferred embodiment will now be described, by way of non-limiting example only, with reference to the accompanying drawing in which:

FIG. 1 is a cross-section of a portion of a prior art spindle assembly, showing an external surface chucking mechanism EXS,

FIG. 2 is a detail of the spindle seen in FIG. 1, where the supporting spindle assembly is deleted,

FIG. 3 shows a cross-section of an internal surface chucking mechanism ISM mounted in the spindle as shown in FIG. 2, according to a first embodiment 100,

FIG. 4 illustrates a partial cross-section showing details of a bushing, as seen in FIG. 3,

FIG. 5 is a partial cross-section exhibiting details of a collet appearing in FIG. 3,

FIG. 6 is a plan view with details of a plunger shown in FIG. 3,

FIG. 7 is a cross-section of a second embodiment 300 of the ISM,

FIG. 8 depicts a detail of a plunger base according to FIG. 7,

FIG. 9 is an opening cone being part of the plunger base of FIG. 7, and

FIG. 10 shows an oil collet, according to the second embodiment 300 of the IMS.

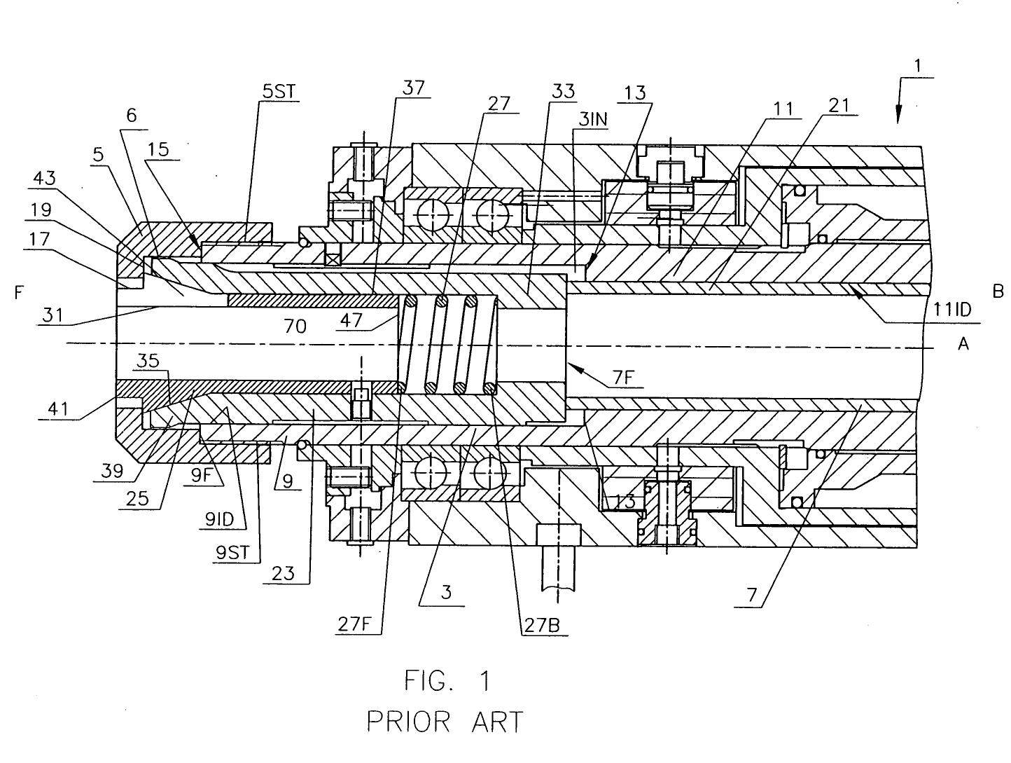

### DESCRIPTION OF THE INVENTION

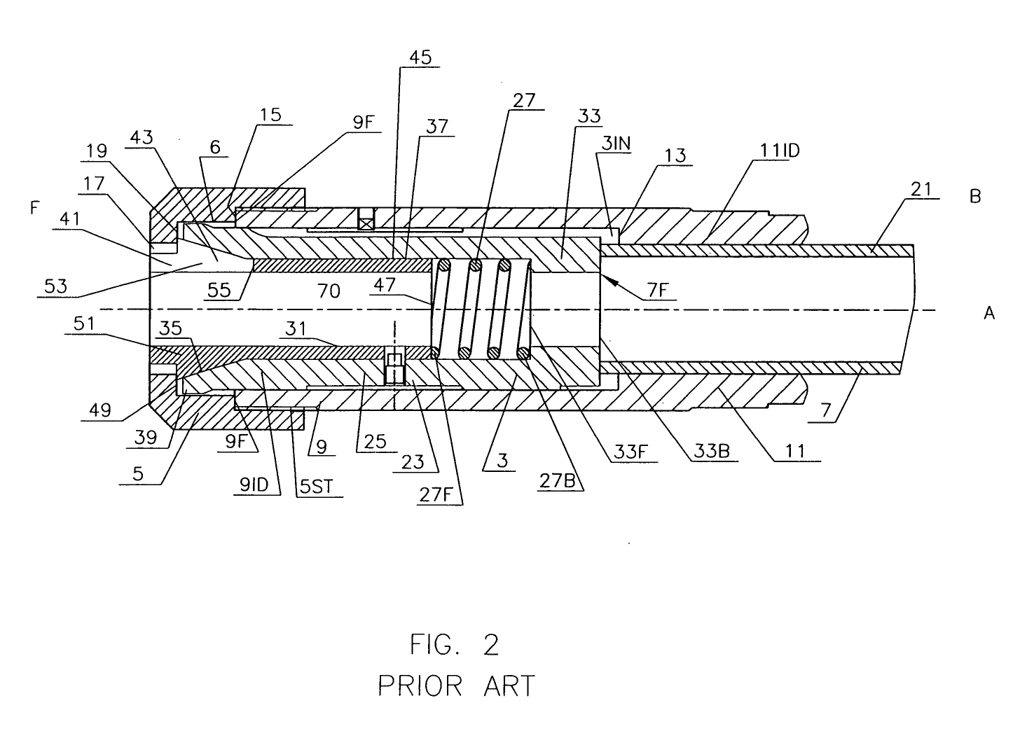

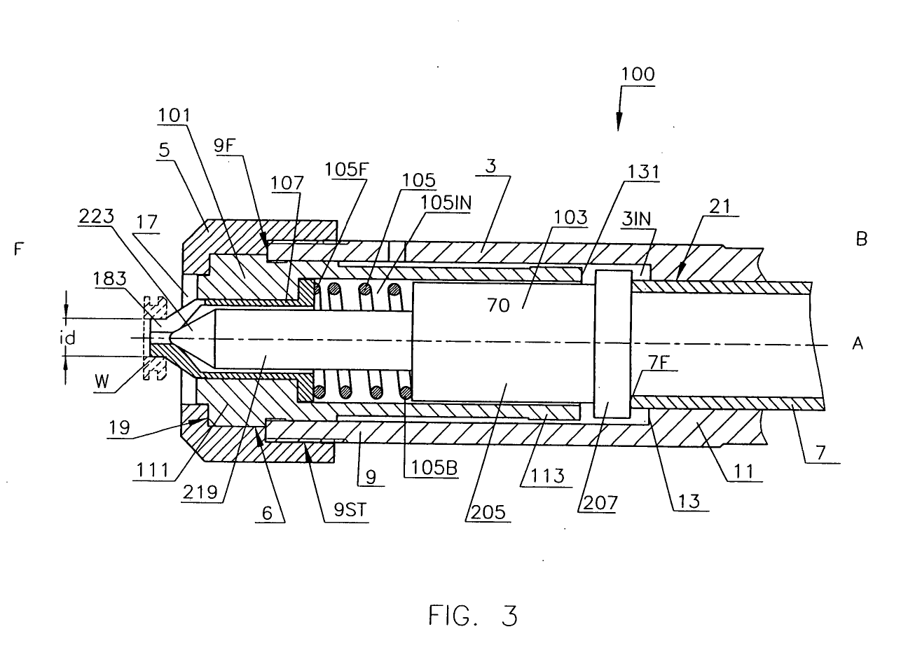

FIGS. 3 to 6 refer to a first embodiment 100 of the IMS. FIG. 3 shows the same axially aligned spindle 3, push rod 7, and cap-nut 5 as seen in FIG. 2, where similar numbers and references indicate corresponding elements in the various Figs. Inside the inner chamber 70 defined as the volume delimited by the inside of the front portion 9 of the spindle 3, frontward of the front facing arresting step 13, and by the cap-nut 5, the EXS has been replaced by the first preferred embodiment 100 of the ISM, referred to as ISM100. The ISM100 is made of a bushing 101, a plunger 103, a spring 105, and a collet-107, all axially aligned with the spindle 3, along the axis A. The bushing 101 serves as a housing for interfacing the coupling mechanism, which is defined as being composed of the plunger 103, the spring 105 and the collet 107, with the spindle 3. The bushing outside is supported by the spindle 3 and the bushing inside houses the coupling mechanism.

With processing machinery such as lathes, the ISM rotates and some components thereof translate relatively to the spindle 3. Coupling for rotation is achieved either by friction or by help of coupling means, while translation requires grooves and engaging means. Nevertheless, keys or pins, and corresponding grooves and bores for providing common rotation and relative translation are not shown in the Figs. and are not described, since these techniques are well known to the art.

To keep the description simple, only the functional properties and details of the machine parts referred to are presented, while relieves, rounded-off corners, chamfers and the like, are deleted.

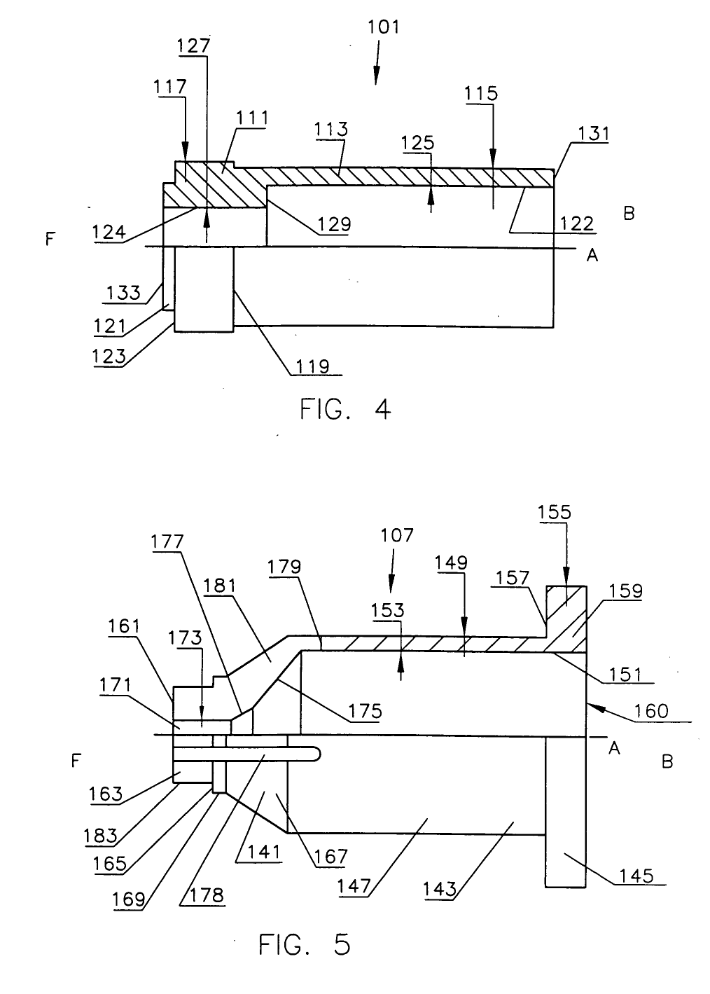

Referring to FIG. 4, the axi-symmetric hollow bushing 101, which rotates together with the spindle 3, has a front portion with a bushing head 111, and a back portion with a bushing body 113. On the outside, the bushing body 113 and the bushing head 111 each have a cylindrical surface with uniform outer diameter. The outer diameter 115 of the bushing body 113 being smaller than the outside diameter 117 of the bushing head 111, a back facing radially extending annular spindle shoulder 119 is created, perpendicular to the longitudinal axis A, for abutment with the front extremity 9F of the spindle 3. In the description below, all shoulders and flanges extend radially and are annular and perpendicular to the longitudinal axis A.

The outside diameter 117 of the bushing head is dimensioned to fit inside the inner diameter restriction 6 in the cap-nut 5. To the front of the bushing head 111, a small front co-axial cylindrical protrusion 121 dimensioned to accommodate the bore 17 of the cap-nut 5, creates a front facing bushing cap-nut shoulder 123, which rests on the inside of the bottom 19 of the cap-nut 5.

When the bushing body 113, which is accommodated to be received by the front portion 9, is inserted into the front portion 9 of the spindle 3, the bushing head 111, resting on the spindle shoulder 119, remains outside of the spindle, but the bushing body 113 resides inside the front portion 9 of the spindle 3. Fastening the cap-nut 5 on the outside front threaded portion 9ST of the spindle 3 clamps the spindle shoulder 119 against the front extremity 9F of the spindle, and the cap-nut bottom 19 against the bushing cap-nut shoulder 123 to prevent axial translation of the bushing 101 relative to the spindle 3. The bushing 101 is thus only an additional interface for receiving and supporting the plunger 103, the spring 105, and the collet 107, inside the spindle 3.

The inner diameter 125 of the bushing body 113 being larger than the inside diameter 127 of the inner surface 124, in the bushing head 111, a back facing bushing collet shoulder 129 is created. The bushing 101 is terminated by a bushing rear 131 formed as a ring as wide as the difference between the bushing body outer diameter 115 and the bushing body inner diameter 125.

With reference to FIG. 5, the collet 107, which is an internal surface gripping collet, is hollow and features a substantially frusto-conical collet front portion 141, a cylindrical collet body 143, and a collet flange 145. The collet 107 rotates together with the bushing 101.

On the outside, the collet body 143 has a cylindrical outer surface 147 with a constant outer diameter 149 starting at the back of the collet front portion 141 up to the collet flange 145. On the inside, the collet body 143 has a cylindrical inner surface 151 with a constant inner diameter 153.

The collet flange 145, which delimits the back extremity of the collet body 143, extends radially outward to an outer diameter 155, to form a front facing collet-bushing shoulder 157 and a back facing collet rest 159 with a collet opening 160.

The outside profile of the collet front portion 141 is shaped to provide, from the front to the back and with reference to the axis A, a perpendicular front extremity 161, a coaxial cylindrical grip surface 163, a perpendicular front facing indexing shoulder 165, and an external frusto-conical surface 167 separated from the indexing shoulder 165 by a short coaxial cylindrical portion 169. The frusto-conical surface 167 continues to the back to connect with the front of the collet body outer diameter 149. It is noted that the low front facing index shoulder 165 is high enough to register a workpiece W in abutment therewith, for axial reference purposes.

The perpendicular front extremity 161 is pierced by a coaxial cylindrical passage 171 with an internal diameter 173 connecting to an inside conical taper 175 opening-up backward and substantially conforming with the external frusto-conical surface 167, via an intermediate conical section 177. In turn, the inside conical taper 175 blends with the inner diameter 153 of the collet body.

The collet front portion 141 is cut radially by a plurality of slits 178, e.g. three separate equally radially distributed slits 178, running from the axis A outward. Axially, the slits 178 are cut lengthwise in the front extremity 161 of the collet 107, up to the front of the collet body 143, to terminate in a slit end 179, thereby forming three collet fingers 181 cantilevered to the collet body 143 and configured to flex radially outward when urged by an internal force appropriately applied from within the collet 107. It is understood that the minimal number of slits is two radial slits 178, or one diametrical slit. Although this example presents three slits 178, only practical considerations limit the number of slits.

The slits 178 divide the cylindrical internal grip surface 163 into separate radially outward facing jaw pads 183, residing in a normally retracted position. When forced to open, thus to extend radially outward, the jaw pads 183 are configured to grip an inner diameter designated as id in FIG. 3, of a workpiece W to be processed. When the force to open is removed, the jaw pads 183 retract radially inward, to their normally retracted position, whereby the gripped workpiece W is released.

With reference to FIG. 3, the collet 107 resides within the bushing 101. The outer surface 147 of the collet body 143 is received along its entire length by the bushing head 111 inner surface 124. The collet flange outer diameter 155 engages into the inner diameter 125 of the bushing back portion 113 in sliding fit. Likewise, the front facing collet-bushing shoulder 157 of the flange 145 abuts the bushing collet shoulder 129 of the bushing 101 under the pressure of the spring 105, which biases the back facing rest 159 of the collet flange 145. At the front, the jaw pads 183 protrude out of the cap-nut 5, through the cap-nut bore 17. It is noted that the grip surface 163 may be shaped to match the internal shape of the workpiece W to be chucked. The grip surface 163 may thus be cylindrical or polygonal, as required to hold the workpiece.

With reference to FIG. 3, the axi-symmetric plunger 103 is the element that transmits motion and force originating from the push rod 7 for the actuation of the ISM. The push rod 7 drives the plunger 103 to actuate the opening and the closing of the collet fingers 181 of the collet 107, and thereby, respectively, grip and release the inner diameter id of a workpiece W. Gripping is considered as gripping and maintaining grip of the workpiece W for as long as commanded.

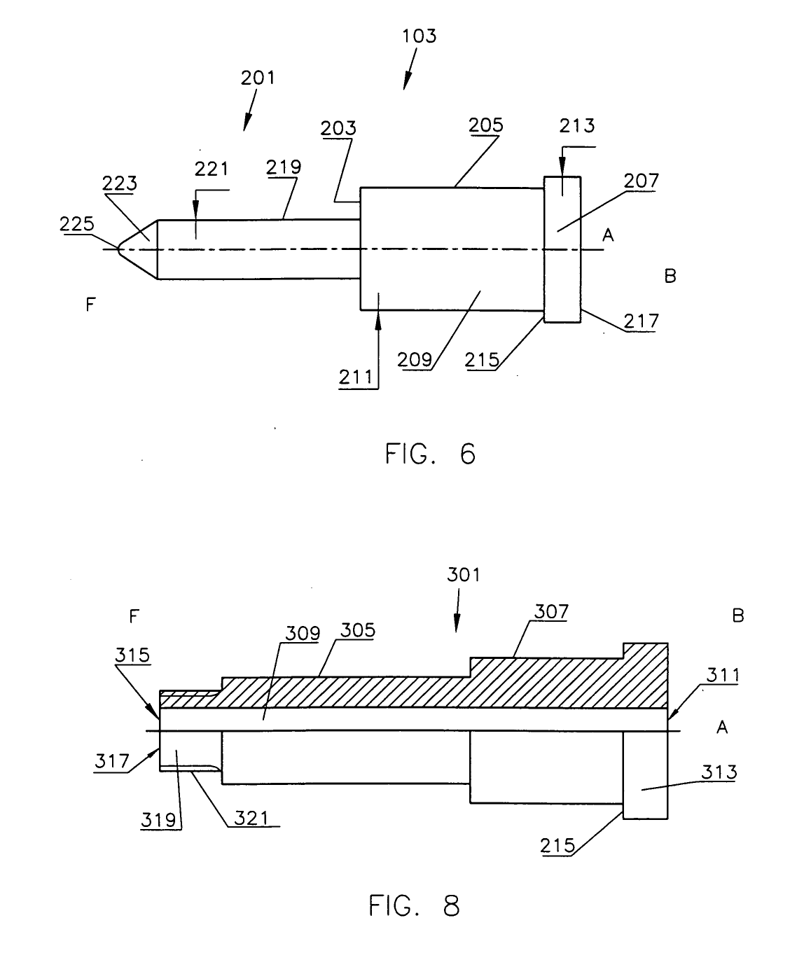

With reference to FIG. 6, the plunger 103 is coaxially axi-symmetric and has a slender plunger rod 201 aligned with and attached in perpendicular to the front face 203 of a plunger body 205, which is terminated by a plunger flange 207 affixed to the back of the plunger body.

The plunger body 205 is configured as a solid cylinder with an outside surface 209 of uniform outside diameter 211, and if so wished, the outside surface 209 may include relieves to form support rings. If further desired, the plunger body 205 may be hollowed out, as well as the plunger 103.

The plunger flange 207, with an outside diameter 213, extends radially outward of the plunger body 205 to form a plunger flange front 215 and a plunger flange back 217.

The plunger rod 201 features a slender cylindrical plunger extender 219 with an outer diameter 221, terminated to the front by a frusto-conical rod head 223 with a plunger front extremity 225, either with a rounded-off tip or terminated by any other type and shape of tip. The rod head 223 conforms to the inside of the intermediate conical section 177 of the collet 107.

As seen in FIG. 3, the outside surface 209 of the plunger body 205 is received in sliding support by the inner diameter 125 of the bushing body 113, which is larger than the outside diameter 211 of the plunger body 205. The plunger flange 207, with an outer diameter 213 larger than the inner diameter 125 but smaller than the outer diameter 115 of the bushing body 113, resides to the back of the bushing rear 131 but to the front of the front facing arresting step 13 of the spindle 3. Furthermore, the plunger flange back 217 is accommodated to abut against the front face 7F of the push rod 7.

To the front of the plunger extender 219, the rod head 223 conforms and abuts with the intermediate conical section 177 of the collet front portion 141, while the outer diameter 221 of the plunger extender 219, is concentrically aligned inside the larger inside diameter 153 of the collet body 143. Moreover, the back end 105B of the spring 105 biases the front face 203 of the plunger body 205.

When assembled inside the front portion 9 of the spindle 3, the collet 107 is received inside the bushing 101 with the collet flange 145 abutting the bushing collet shoulder 129 and with the collet front extremity 161 protruding frontward and out of the opening bore 17 of the cap-nut 5.

The plunger body 205 of the plunger 103 is supported by the inner surface 122 of the bushing body 113, and permits sliding axial translation. The plunger flange 207, which is configured to translate inside the back of the front portion 9 of the spindle 3, is adapted for contact with the open front face 7F of the push rod 7, so that when the push rod 7 extends forwards, that front face 7F pushes the plunger 201 forward. Frontward travel of the plunger flange 207 is limited by the bushing rear 131, while backward translation is stopped by the front facing arresting step 13 in the inside 3IN spindle 3.

The spring 105 is internal to the bushing body 113 and permits the undisturbed translation of the plunger extender 219 through the spring inside 105IN. The front-end 105F of the spring 105 biases the collet flange 145 and the back end 105B of that spring rests on the front facing collet-bushing shoulder 157 of the collet 107. It is noted that the denomination spring 105 refers to one or more resilient elements biasing the collet 107 away from the plunger body 205.

The rod head 223, which abuts the intermediate conical section 177 on the inside of the collet front portion 141, is operated by the frontward translation of the push rod 7 to open the collet fingers 181 for gripping a workpiece W, and when the push rod retreats, it is the spring 105 that pushes the plunger 103 backwards, whereby the collet fingers 181 close to release the workpiece W. The workpiece remains gripped as long as the push rod 7 is extended.

The axial force delivered by the push rod 7 is decomposed in an axial force and into a perpendicular radial outward force applied for opening the jaws 181. Therefore, the more the rod head 223 translates forward, the more the jaw pads 183 are urged in outward radial separation, and the better and with more force the inner surface of a workpiece W is gripped.

It is noted that the closer the intermediate conical section 177 is to the collet front extremity 161, and thus the more the rod head 223 penetrates frontward and closer to the outward facing jaw pads 183, the less bending moment is imposed on the collet fingers 181. The bending moments and the axial forces are lower the sharper the angle of the rod head 223 and of the mating intermediate conical section 177.

The forward translation of the push rod 7 is controlled to correctly operate the ISM, without excess translation that might cause damage. Excess forward travel or force applied by the push rod 7 will not damage the collet 107 since the force applied by the front face 7F to the plunger flange 207 will be countered by the bushing rear 131.

For use of the ISM100 on a processing machine, the push rod 7 is first withdrawn to the retracted position, backward enough to prevent transmission of force to the collet 107. When force is not applied on the collet 107, the jaws 181 are unextended. A workpiece W with an inside surface may now be placed on the outward facing jaws pads 183. Next, the push rod face 7F is translated forward to contact the plunger 103, pushing the plunger flange 207 forward, thereby forcing the rod head 223 to engage the collet fingers 181, which then open up and grip the inside surface of the workpiece W.

In general, it is possible to manufacture an external surface in a workpiece W, if not already existing. The EXS, which grips the workpiece on an external surface, may be of use to machine the internal surface, even if necessary only for purposes of manufacturing. The internal surface is possibly made a priori.

In manufacturing, the benefits of the simple reversible exchange of an EXS with an ISM100 come to full exploitation. When an installed EXS has to be replaced by an ISM100 in a spindle assembly 1, the following steps are performed. It is assumed that an assembled ISM100 is at hand, with the spring 105 mounted on the plunger extender 219, both already inserted inside the collet body 143, and residing inside the front portion 111 of the bushing 101.

a. With the spindle 3 stopped and the push rod 7 retreated to the back, the cap-nut 5 is unscrewed and removed from the spindle, thereby exposing the open front portion 9 of the spindle 3.

b. The EXS is retrieved by pulling the collet actuator 23 out of the open front portion 9 of spindle 3.

c. The ISM100 is introduced into the open front face 9F of the spindle 3, with the plunger flange 207 being inserted first.

d. The cap-nut 5 is seated over the bushing cap-nut shoulder 123, in screw-threaded engagement with the external screwthread 9ST, and secured in place.

The procedure for the exchange of an ISM100 with an EXS is essentially the same. This time, it is the ISM100 that is retrieved from the open front portion 9 of the spindle 3 by pulling out the bushing 101, and replaced by the EXS, with the back introduced first. Advantageously, the initial external configuration of the processing machine equipped with the EXS is not altered when in use with an ISM.

In industry, a processing machine equipped with two spindles, independent or not, wherein each spindle operates an EXS, in mutual opposite axial alignment and translation, is also economically beneficial. In regular operation, a workpiece W, machined from stock material automatically fed as one piece into the processing machine, is first gripped by a first EXS mounted in a first spindle, and processed as required, on the surface not covered by the first EXS. Thereafter, a second EXS, in alignment with the first EXS, and mounted on the second spindle which operates as a counter spindle, grips the workpiece W for further processing. This further processing may simply only cut the workpiece W off the stock material, or feature additional processing operations. As was explained above, the gripping jaws possibly blemish the outer surface finish of the workpiece.

In the above-mentioned case, it is advantageous to exploit the present invention and replace the EXS held in the second spindle, thus in the counter-spindle aligned with the EXS, with an ISM100. The processing machine then presents a first spindle with an EXS is alignment with a second spindle supporting an ISM100. When the EXS of the first spindle processes the workpiece W, an internal surface facing the counter spindle, is also machined, if not available a priori, for later gripping by the ISM100. Before completion of the processing of the workpiece W held by the EXS, the ISM100 is brought to the same rotational speed as the EXS and is translated to approach and grip the workpiece W. It is now possible to continue processing of the workpiece W, which is gripped by both the EXS and the ISM.

When processing related to the gripping with the EXS is completed, the workpiece W, already gripped by the ISM100 is cut-off on the side of the EXS, thereby remaining gripped solely by the ISM100 on the counter spindle. If desired, the workpiece W is indexed to abut the front facing indexing shoulder 165 for registration. With or without registration, the workpiece W is now ready for further processing.

Registration is achieved by pushing the workpiece W held by the ISM100 against a surface, releasing grip of the ISM100 so that the applied pressure will translate the workpiece W in abutting contact with the indexing shoulder 165 and then, gripping the workpiece W with the ISM100 again. As stated above, the operation of the push rod 7 opens and closes the grip of the ISM100 on the internal surface of the workpiece W.

For example, a profiled contour along the overall external length of the workpiece W may be machined, or marks left on the external outer surface of the workpiece W may be obliterated by additional processing when gripped by the ISM100. Simultaneously, processing of a next workpiece may commence on the first spindle with the EXS, even before completion of the present workpiece W on the counter spindle with the ISM100. Inherently, the ISM will not leave marks on the outside of the workpiece W.

A production facility may possibly store not one ISM100 tool but a family of such tools, where each one ISM100 is specified by the inner surface size and shape able to be gripped by the collet 107. Another approach is to store only a collection of collets 107, for exchange and replacement within an ISM100. The collets 107, out of the collet collection, are interchangeable and are chosen from a variety of standard or custom made collets. In process, a collet is selected according to the shape and size of the bore or the internal surface opened in the workpiece W.

To replace a first collet 107 residing inside an ISM by a second other collet, it is necessary to slide the plunger 103 and the spring 105 out of the bushing 101 of the ISM100 assembly. Then, the first collet 107 is slid out, or pushed to slide out of the bushing 101. Next, the spring 105 is mounted around the plunger extender 219 on top of which the second other collet is slid concentrically. As a last step, the bushing 101 is assembled concentrically over the second other collet and the plunger 103 is introduced into the bushing whereby the ISM100 is reassembled.

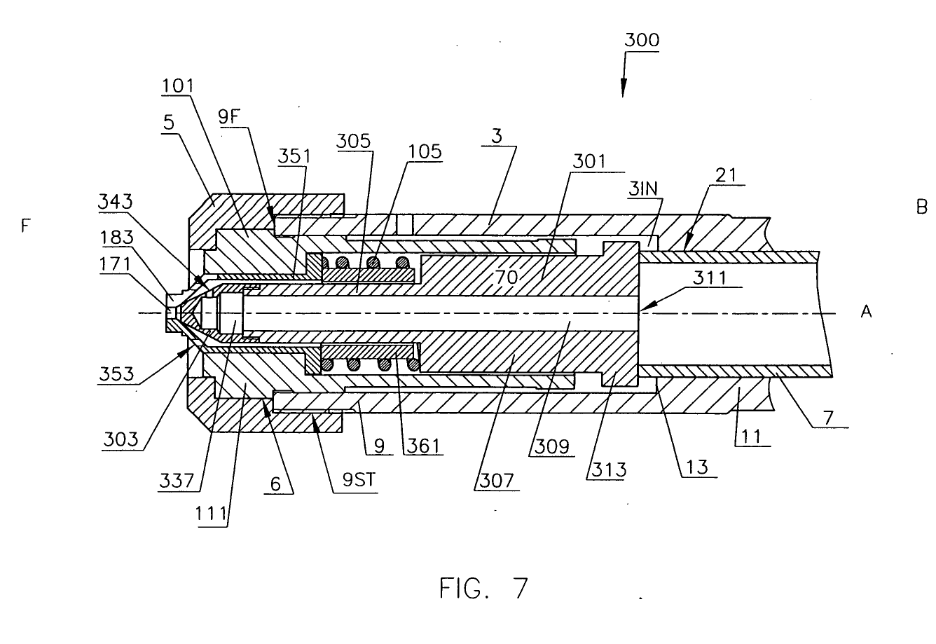

A second preferred embodiment 300 of an internal surface chucking mechanism ISM300 is described below with reference to FIGS. 7 to 10. In general, the ISM 300 shown in FIG. 7 is similar to the ISM100 depicted in FIG. 3, but for the possibility to introduce fluid under pressure to the inside of the ISM300. The received fluid is released as a stream out of the front portion of the collet, opposite the retained workpiece, to eject the workpiece from the ISM300 when the grip is released. The fluid, such as oil if desired, cools and lubricates the ISM300 and the workpiece. Furthermore, the release of fluid prevents the ingress of matter from the outside into the inside of the ISM300.

To facilitate the production of a plunger with an inside fluid conduit, the plunger 103 is possibly made of more than one part. In addition, the collet 107 is provided with oil outlets. As an alternative, a sleeve is inserted inside the spring 105, to arrest the frontward translation of the push rod 7. Similar numbers and references are used to indicate corresponding elements in the various Figs.

The ISM300 resides in the inner chamber 70 defined above, and is retained therein by the cap-nut 5 and the bushing 101, as with the ISM100. Unlike the ISM100 shown in FIG. 3 with a single-piece plunger 103, the plunger of the ISM300 is segmented for ease of manufacturing, and built out of two or more parts coupled together, as desired.

As above, the keys or pins and corresponding grooves and bores, possibly used for the coupling of jointly rotating parts and for relative translation displacement are not mentioned, for the sake of simplicity. Only functional features of the machine parts are depicted and described.

With reference to FIG. 7, the segmented plunger 301 is a made, for example, of two separate sections coupled together, namely a plunger base 301 and a separate opening cone 303, resembling the rod head 211 of the ISM100.

In FIG. 8, the plunger base 301 is shown with a front plunger pipe 305, and a plunger main body 307, both connected on the inside by an axial bore 309 of constant or variable inner diameter, accommodated for the passage of fluid. The axial bore 309 extends from a flange inlet 311 opened in a hollow flange 313 at the back of the plunger main body 307. The plunger pipe 305 is coupled to a front face 314, to the front of the plunger main body 307. The axial bore 309 ends in a plunger pipe outlet 315 open at the front extremity 317 of the plunger pipe 305. A recessed external cylindrical surface 319, at the front extremity 317 of the plunger pipe 305, carries a external screwthread 321, but is only an example of a coupling means to the opening cone 303, out of the many possible coupling connections known to the art.

Once the plunger base 301 is coupled together in assembly with the opening cone 303, the geometry and dimensions of the assembly are the same as those of the plunger 103. However, if desired, the plunger base plunger 301 may itself be implemented as two or more parts coupled together. For example, by producing separately the plunger pipe 305 and the plunger main body 307, and then coupling both together by conventional means.

The flange inlet 311 is accommodated to receive fluid, such as oil, from a source not shown in the Figs. That fluid is then discharged via the pipe outlet 315. Oil is possibly supplied from the processing machine itself of from an external source.

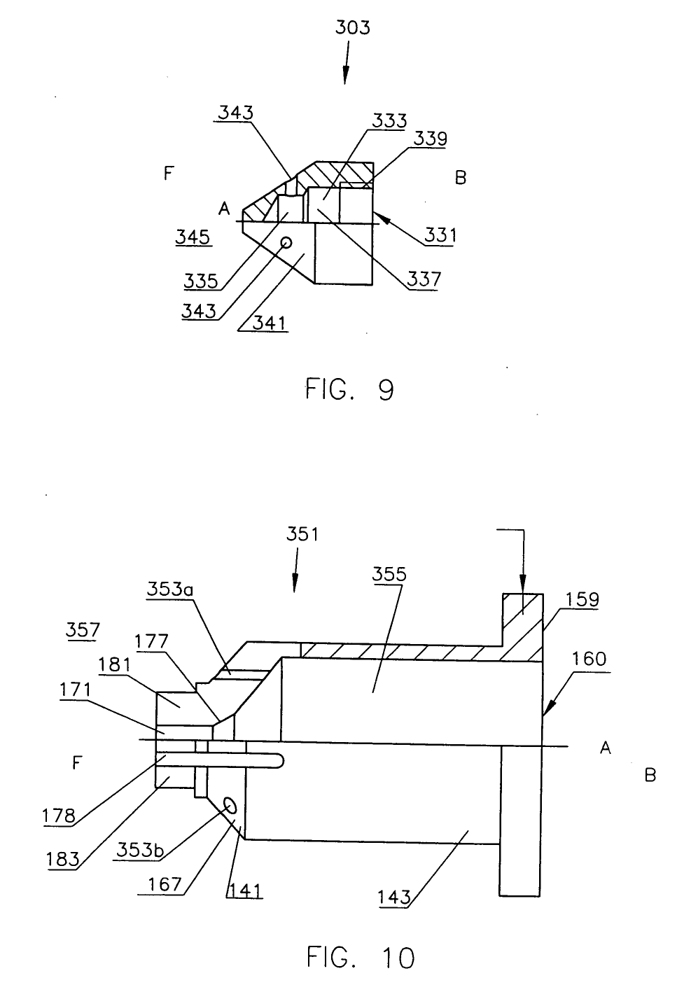

FIG. 9 is an illustration of the hollow opening cone 303, configured for passage of fluid therethrough and for attachment to the plunger pipe outlet 315. If desired, the attachment is releasable, to permit exchange and replacement of the opening cone 303. Means for coupling and for releasing of the hollow opening cone 303 and of the plunger pipe outlet 315, such as facets, are not shown.

At the back of the hollow opening cone 303, a cone rear inlet 331 leads to a hollow inside 333 formed by a leading bore 335 and a trailing bore 337. An internal screw thread 339, accommodated at the rear inside of the trailing bore 337, permits coupling of the hollow opening cone 303 with the external screwthread 321 located at the front extremity 317 of the plunger pipe 305. Coupling of the hollow opening cone 303 to the plunger pipe outlet 315 is possibly achieved by other means, all well known to the art.

On the external frusto-conical surface 341 of the hollow opening cone 303 there is provided at least one radial flow bore 343, entered for radial fluid flow communication with the leading bore 335. When the hollow opening cone 303 is coupled to the plunger pipe 305, fluid flow communication is established from the flange inlet 311 of the plunger base 301 via the axial bore 309 and the hollow inside of the hollow opening cone 303, to the radial flow bore 343, and from there, to the external frusto-conical outside and thus to the opening cone outside 345.

FIG. 10 is an oil collet 351, alike the collet 107 of embodiment ISM100, but for fluid outlet passage openings at the front. One or more axial fluid outlet passages 353 are bored into the external frusto-conical surface 167 of the oil collet 351. For example, three axial fluid outlet passages 353, of which only two, designated as 353a and 353b are seen in FIG. 10, are distributed each at a different parallel distance from the axis A of the oil collet 351, opening a fluid passage from the oil collet inside 355 to the external frusto-conical surface 167 and to the outside 357. Fluid, such as oil, is thus able to flow out of the oil collet inside 355 and from there to the oil collet outside 357 via the slits 178, and the at least one axial fluid outlet passage 353. If the opening cone 303 is configured therefor, such as by piercing an axial bore therein, oil may even exit via the axial cylindrical passage 171.

The ISM300 is seen assembled in FIG. 7, with the hollow plunger base 301 coupled to the opening cone 303, which resides inside the oil collet 331. As described above, fluid flow communication is established from the flange inlet 311 to the axial fluid outlet passage(s) 353, and thus to the front of the cap-nut 5.

The fluid is delivered to the oil collet 351 under controlled command, either automatic or manual and selectable to operate, constantly or during chosen periods, either continuously or intermittently, according to the processing activity of the processing machine operating the ISM300. If preferred, the fluid is a liquid and if desired, the liquid is oil, for cooling and for lubrication.

When a fluid, such as oil for example, is introduce to the inside 355 of the oil collet 351, that oil will serve to lubricate the external frusto-conical surface 341 of the opening cone 303, the intermediate conical section 177 of the oil collet 351, and the components of the ISM 300. The oil will also cool the ISM 300. The exact location and orientation of the fluid communication passages is not crucial, as long as the oil flows over the intermediate conical section 177 and the external frusto-conical surface 341.

The axial fluid outlet passages 353 bored axially in the external frusto-conical surface of the oil collet 351 serve as outlets for continuous or intermittent jets or streams of oil directed upon command, to eject the workpiece W from the collet fingers 181, when the outward facing jaw pads 183 are released. These same oil jets do also cool the workpiece W.

Furthermore, the oil exiting out of the inside 355 to the oil collet outside 357, from via the slits 178, and the at least one axial fluid outlet passage 353 prevent the ingression of matter, such as particles, dirt, and contaminants, to the inside of the oil collet 351 and of the ISM300. Such particles may be substance removed from the workpiece W during process, such as chips of material, cutting tool or grinding tool particles, and the like.

The spring 105 is possibly configured as a compression spring made from circular, rectangular or other coil cross-section, either as a single spring or as a plurality of concentric springs.

A stop sleeve 361, which is but a cylindrical hollow bushing with uniform outside and inside diameter, may be inserted inside the spring 105 and over the plunger pipe 305, as seen in FIG. 7, to constrain the forward motion of the push rod 7. A first end of the stop sleeve 361 rests against the collet rest 159 while the plunger flange front 215 of the plunger base 301 supports a second end of the stop sleeve 361. This last arrangement may replace the arrest of the push rod 7 on the bushing 101 by intermediary of the plunger flange 207, as an alternative for the configuration described above for the ISM100. The length of the stop sleeve 361 is adjustable to suit requirements. The stop sleeve 361 is replaceable and exchangeable.

Still with reference to FIG. 7, the ISM300 is shown assembled in operative condition. When compared to the ISM 100, the ISM300 permits replacement and exchange of the opening cone 303, of the oil collet 331, and of the stop sleeve 361. Both the opening cone 303, and the oil collet 331, which suffers wear and tear, are made to resist heavy duty operation by producing them for harsh service, from resistant materials, duly heat and surface treated with appropriate processing and finish.

In comparison with the ISM100, the ISM300 is configured to perform as an ISM100, while providing the advantages described above and related to the fluid conduits and to the flow of fluid. As stated before, the ISM is not limited to rotative processing machinery but operates also with non-rotative equipment. The process wherewith the ISM is operable are not limited to spindles for removing chips of material, such as with lathes. The ISM operates as well with machines for fastening, for joining, for surface treatment for quality assurance, and with other equipment.

It will be appreciated by persons skilled in the art, that the present invention is not limited to what has been particularly shown and described hereinabove. For example, the mechanism of the ISM may be modified and the conduit of fluid altered. Furthermore, the processing of a workpiece is not limited only to a first processing step when gripped by an EXS and to a second processing step when gripped by an ISM. In addition, more than just one EXS and one ISM may be used for processing a workpiece. Rather, the scope of the present invention is defined by the appended claims and includes both combinations and sub-combinations of the various features described hereinabove as well as variations and modifications thereof which would occur to persons skilled in the art upon reading the foregoing description.

1. An internal surface chucking mechanism (ISM) having a coupling mechanism activable for gripping and for release of a workpiece in process on a processing machine, the workpiece defining an external surface and an internal surface configured for access from the outside, and at the processing machine:
an inner chamber having an axis (A) and a volume of space inside the processing machine,
an external surface chucking mechanism (EXS) releasably and retrievably retained in axial alignment in the inner chamber and configured for gripping and for releasing an external surface of the workpiece in process on the processing machine,
a push rod operatively associated with the EXS to controllably command gripping and release of the external surface of the workpiece in process, whereby retrieval of the EXS from the inner chamber and insertion therein of the IMS in replacement, provides operation of the processing machine in a first configuration with an EXS, and in a second configuration with an ISM, and vice versa,
the ISM further having a bushing with a bushing outside and a bushing inside, the bushing outside being configured to be retrievably received in axial alignment inside the inner chamber, and the bushing inside being configured for receiving the coupling mechanism, and
the coupling mechanism having a collet with jaw pads on collet fingers normally in retracted position, and extensible radially outward to grip the workpiece, a plunger with a rod head, and a spring biasing the plunger away from the collet, and the ISM being configured for insertion and retention in the inner chamber, and for retrieval therefrom, to provide reversible exchange in replacement of the EXS, in operative association with the push rod to activate the coupling mechanism: comprising
forward translation of the push rod against the plunger for urging the rod head against the collet fingers for the jaw pads to grip an inner diameter of the workpiece, while biasing the spring between the plunger and the collet, and
backward translation of the push rod away from the plunger causing the spring to actively bias the plunger backward, and the jaw pads to retract radially inward, whereby the gripped workpiece is released.

2. The ISM according to claim 1, wherein
the ISM is operable with a processing machine operating a process selected, alone and in combination, from the group of processes consisting of material removal, fastening, joining, surface treatment, and quality assurance.

3. The ISM according to claim 1, wherein
the ISM is configured for operation both when rotative and when non-rotative.

4. The ISM according to claim 1, wherein
the ISM is operable with a processing machine having a rotating spindle.

5. The ISM according to claim 1, wherein the ISM and the EXS are mutually and reversibly exchangeable in situ.

6. The ISM according to claim 1, wherein:
the processing machine has an initial external configuration when operating an EXS, and
exchange of the EXS with the ISM maintains unaltered the initial external configuration of the processing machine.

7. The ISM according to claim 1
wherein
the bushing is configured for retention in the processing machine inside the spindle, which has an outside front threaded portion accommodated for fastening a cap-nut thereon, and
when the bushing is received in axial alignment inside the inner chamber, and the cap-nut is fastened to the spindle, axial relative translation between the bushing and the spindle is prevented.

8-14. (canceled)

15. A method for providing an internal surface chucking mechanism (ISM) having a coupling mechanism activable for gripping and for release of a workpiece in process on a processing machine, the workpiece having an external surface and an internal surface configured for access from the outside,
at the processing machine:
an inner chamber having an axis and a volume of space inside the processing machine,
an external surface chucking mechanism (EXS) releasably and retrievably retained in axial alignment in the inner chamber and configured for gripping and for releasing the external surface of the workpiece in process on the processing machine,
a push rod operatively associated with the EXS to controllably command gripping and release of the external surface of the workpiece in process,
whereby retrieval of the EXS from the inner chamber and insertion therein of the IMS in replacement, provides operation of the processing machine in a first configuration with an EXS, and in a second configuration with an ISM, and vice versa,
the ISM further has a bushing with a bushing outside and a bushing inside, the bushing outside being configured to be retrievably received in axial alignment inside the internal chamber, and the bushing inside being configured for receiving the coupling mechanism, and
the coupling mechanism has a collet with jaw pads on collet fingers normally in retracted position, and extensible radially outward to grip the workpiece, a plunger with a rod head, and a spring biasing the plunger away from the collet, and the ISM is configured for insertion and retention in the inner chamber, and for retrieval therefrom, to provide reversible exchange in replacement of the EXS, for operative association with the push rod to activate the coupling mechanism, comprising:
translating the push rod forward against the plunger for urging the rod head against the collet fingers for the jaw pads to grip an inner diameter of the workpiece, while biasing the spring between the plunger and the collet, and
translating the push rod backward away from the plunger, causing the spring to actively bias the plunger backward, and for the jaw pads to retract radially inward, whereby the gripped workpiece is released.

16. The method according to claim 15, wherein
the ISM is operable with a processing machine for running a process selected, alone and in combination, from the group of processes consisting of material removal, fastening, joining, surface treatment, and quality assurance.

17. The method according to claim 15, wherein
the ISM is configured for operation both when rotative and when non-rotative.

18. The method according to claim 15, wherein
the ISM operates with a processing machine having a rotating spindle.

19. The method according to claim 15, wherein
the ISM is replaceable with the EXS in situ, in mutual and reversible exchange.

20. The method according to claim 15, wherein:
the processing machine has an initial external configuration when operating an EXS, and
the initial external configuration of the processing machine remains unaltered after exchange of the EXS with the ISM.

21. The method according to claim 15, wherein
the bushing is configured for retention in the processing machine inside the spindle, which has an outside front threaded portion accommodated for fastening a cap-nut thereon, and
when the bushing is received in axial alignment inside the inner chamber, and the cap-nut is fastened to the spindle, axial relative translation between the bushing and the spindle is prevented.

22-28. (canceled)
